(19) United States
(12) Patent Application Publication
(10) Pub. No.: US 2024/0249606 A1
(43) Pub. Date: Jul. 25, 2024

(54) INTERACTIVE LIGHT SWITCH ACCESSORY APPARATUS

(71) Applicant: Flick Power, Fountain Valley, CA (US)

(72) Inventors: Andre Ramirez, Fountain Valley, CA (US); Daniel J. Hienzsch, Fountain Valley, CA (US)

(21) Appl. No.: 18/417,597

(22) Filed: Jan. 19, 2024

Related U.S. Application Data
(60) Provisional application No. 63/480,916, filed on Jan. 20, 2023.

(51) Int. Cl. G08B 5/36; H01H 9/02

(52) U.S. Cl. CPC G08B 5/36; H01H 9/0271

(57) ABSTRACT

The present disclosure relates to an interactive light switch accessory apparatus. The apparatus comprises an electronic plate device mounted to a surface. The plate device comprising at least one opening to accommodate to at least one switch mounted to the surface. The apparatus further comprises one or more light emitting elements disposed in the plate device, and a computing module in communication the light emitting elements and the plate device. The apparatus further comprises one or more sensors in communication with the plate device configured to collect information related to the environment proximal to the plate device. The plate device is configured to communicate information to a user.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

The present application claims the benefit of U.S. patent Application No. 63/480916, filed Jan. 20, 2023, which is hereby incorporated by reference in its entirety herein.

### BACKGROUND

### Field

The present disclosure generally relates to an interactive system, and, more particularly, to an interactive light switch accessory apparatus for displaying and communicating information.

### Description of the Related Art

Systems to communicate and display information such as weather, advertisement and news has become a part of everyday life. Existing systems provide general information suitable for all audiences through communication channels such as smart phones, televisions, and mail.

At present, an individual needs to search for desired information in their mobile phone or other device, without taking steps to search for the information the individual may not receive relevant information as it is provided through communication channels, which are currently crowded out by significant other information.

### SUMMARY

The embodiments disclosed herein each have several aspects no single one of which is solely responsible for the disclosure's desirable attributes. Without limiting the scope of this disclosure, its more prominent features will now be briefly discussed. After considering the discussion, and particularly after reading the section entitled “Detailed Description,” one will understand how the features of the embodiments described herein provide advantages over existing systems, devices and methods for an interactive light switch.

The following disclosure describes non-limiting examples of some embodiments. For instance, other embodiments of the disclosed systems and methods may or may not include the features described herein. Moreover, disclosed advantages and benefits may apply only to certain embodiments of the invention and should not be used to limit the disclosure.

There exists a need for information targeted to a particular individual or individuals living in a particular place. Therefore, a display and communication apparatus that provides targeted information for the particular individual is desired. Further, there is a need for an apparatus that could be installed at a location often accessed by the user and could provide information specific to the individual and environment where the apparatus is mounted.

The present disclosure discloses an interactive light switch accessory plate apparatus. The apparatus comprises at least one electronic plate device configured to function as a cover plate or attachment for one or more light switches.

The apparatus further comprises a computing module, at least one display module, a communication module, and one or more sensors. The communication module is configured to facilitate communication between the apparatus and one or more external devices via a network. The sensors are configured to collect information related to the environment proximal to the plate device. The sensors are configured to collect information including, but not limited to, temperature, humidity and air quality of the environment at where the plate device is installed. The information collected by the sensors are communicated to the plate apparatus.

The apparatus further comprises a power source module including at least one power source. The power source module is configured to supply power to the apparatus. The power source module is further configured to control and vary the power supplied to the apparatus based on one or more conditions, which includes, but not limited to, environmental condition.

The plate device is the display module configured to display and communicate information to the user. In another embodiment, the plate device comprises a display module on at least a portion of the plate device. The display module is configured to display and communicate information. In yet another embodiment, the plate device comprises one or more light emitting elements to communicate information. The light emitting elements comprises one or more light emitting diodes (LEDs). In yet another embodiment, the plate device is a visual screen (e.g., electronic ink or E-ink or electrophoretic display) configured to display and communicate information to the user. The information includes, but not limited to, air quality, environmental information, weather information, information related to time of one or more countries, information configured by the user and status of the devices connected to the apparatus. The information may further include utility price rate, utility information or status of overall usage and resulting bill amounts for the utilities consumed by an environment having one or more devices. The plate device is configured to communicate the utility information via the light emitting elements.

In one aspect, an interactive plate apparatus includes an electronic light switch device mounted to a surface at least partially surrounding a light switch. The electronic light switch accessory device includes at least one opening, one more light emitting elements (e.g., LEDs), a computing module, and one or more sensors. The at least one opening is sized to receive the light switch. The one or more light emitting elements are disposed on the electronic light switch accessory device. The computing module is configured to be in communication with the light emitting elements and the electronic light switch accessory device. The one or more sensors are configured to collect information related to an environment surrounding the light switch accessory device. The one or more sensors are in communication with the electronic light switch accessory device. The electronic light switch accessory device is configured to communicate information to a user.

Various embodiments of the various aspects may be implemented. In some embodiments, the electronic light switch accessory device comprises a display module. In some embodiments, the electronic light switch accessory device is configured to communicate localized information relevant to one or more specific users of the electronic light switch accessory device. In some embodiments, the electronic light switch accessory device is configured to communicate via at least one of a screen (e.g., electronic ink or E-ink or electrophoretic display) and the one or more light emitting elements (e.g., LEDs). In some embodiments, the electronic light switch accessory device is configured to display information related to the environment or a particular time. In some embodiments, the display module is an electronic paper screen. In some embodiments, at least one of the one or more sensors are configured to detect a user's presence. In some embodiments, the interactive plate apparatus transitions to a power saving mode when a user's presence is not detected.

In another aspect, a light switch accessory at least partially surrounding a light switch includes at least one opening, one or more sensors, and a display module. The at least one opening is sized to receive the light switch. The one or more sensors are configured to receive information from an environment surrounding the light switch accessory. The display module is configured to display the information received by the one or more sensors.

Various embodiments of the various aspects may be implemented. In some embodiments, the accessory further comprises one or more light emitting elements configured to display one or more predetermined colors representing a predetermined set of information. In some embodiments, the light switch accessory is configured to communicate information to a user device. In some embodiments, the display module is an electronic paper screen. In some embodiments, the one or more light emitting elements display a first color to communicate a first set of information and wherein the one or more light emitting elements display a second color to communicate a second set of information, the second color is different than the first color. In some embodiments, at least one of the one or more sensors are configured to measure environmental conditions and air quality.

In another aspect, a method of displaying information on a light switch accessory includes detecting information from an environment where the light switch accessory is positioned using one or more sensors positioned on the light switch accessory, detecting a user's presence using the one or more sensors, and displaying at least a portion of the information detected on at least one of a display module or one or more light emitting elements.

Various embodiments of the various aspects may be implemented. In some embodiments, the method further comprising communicating the detected information to a user device. In some embodiments, the method further comprises transitioning the light switch accessory to a power save mode when the user's presence is no longer detected. In some embodiments, the method further comprises the one or more light emitting elements displaying a first color to communicate a first set of information and displaying a second color to communicate a second set of information, wherein the second color is different than the first color. In some embodiments, the method further includes displaying the detected information using a projector.

In another aspect a method of mounting a light switch accessory includes positioning a mounting plate around a light switch. The method also includes aligning the mounting plate with a screw. The method also includes inserting a mounting key into a key slot of the mounting plate, such that a cutout of the mounting key is positioned at least partially around a shaft of the screw. The method also includes tightening the screw to the secure the mounting key and mounting plate to a surface. The method also includes positioning the light switch accessory over the mounting plate.

Other objects, features and advantages of the present innovation will become apparent from the following detailed description. It should be understood, however, that the detailed description and the specific examples, while indicating specific embodiments of the innovation, are given by way of illustration only, since various changes and modifications within the spirit and scope of the innovation will become apparent to those skilled in the art from this detailed description.

### BRIEF DESCRIPTION OF THE DRAWINGS

The foregoing summary, as well as the following detailed description of the innovation, is better understood when read in conjunction with the appended drawings. For the purpose of illustrating the innovation, exemplary constructions of the innovation are shown in the drawings. However, the innovation is not limited to the specific methods and structures disclosed herein. The description of a method step or a structure referenced by a numeral in a drawing is applicable to the description of that method step or structure shown by that same numeral in any subsequent drawing herein.

FIG. 1 is a block diagram showing example components of an interactive light switch accessory apparatus, according to an embodiment of the present disclosure.

FIG. 2 is a perspective view of a plate device, according to an embodiment of the present disclosure.

FIG. 3 is a perspective view of another embodiment of a plate device, according to an embodiment of the present disclosure.

FIG. 4A is a front perspective view of another embodiment of a plate device, according to an embodiment of the present disclosure.

FIG. 4B is a rear perspective view of the plate device of FIG. 4A, according to an embodiment of the present disclosure.

FIG. 4C is an example embodiment of a mounting plate, according to an embodiment of the present disclosure.

FIG. 4D is an example embodiment of a mounting key, according to an embodiment of the present disclosure.

FIGS. 5A-5F illustrate an example embodiment of mounting the plate device of FIG. 4A using the mounting plate of FIG. FC and mounting keys of FIG. 4D.

### DETAILED DESCRIPTION

A description of embodiments of the present innovation will now be given with reference to the Figures. It is expected that the present innovation may be embodied in other specific forms without departing from its spirit or essential characteristics. The described embodiments are to be considered in all respects only as illustrative and not restrictive.

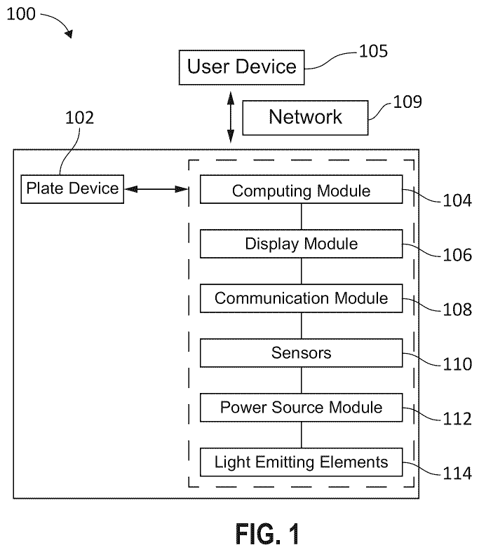

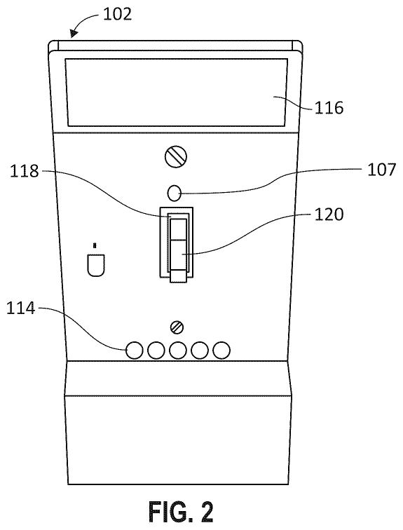

Referring to FIG. 1, an interactive light switch accessory apparatus 100 for a switch 120 (shown in FIG. 2) is schematically shown. The light switch accessory apparatus 100 can comprise at least one electronic plate device 102. The electronic plate device 102 may also be referred to as an electronic light switch accessory 102. The light switch accessory apparatus 100 may also be referred to as an interactive plate apparatus 100. The plate device 102 may function as a cover plate for one or more switches 102, for example the plate device 102 may at least partially surround the physical light switch, for example as shown in FIG. 2. The plate device 102 may be positioned at an area proximal to the switch 120. The apparatus 100 may operate as a wireless communicating switch plate.

The apparatus 100 may comprise a computing module 104, at least one display module 106, a communication module 108, and one or more sensors 110. The sensors 110 may collect information related to the environment the apparatus 100 is disposed in. For example, the sensors 110 may collect information including, but not limited to, temperature, humidity, noise, motion and occupancy patterns, and air quality of the environment at where the apparatus 100 is installed. In some embodiments, the information collected may be related to the room, building, and/or house that the apparatus 100 is installed in. The apparatus may be installed in an outdoor environment, indoor environment, or a combination therein.

The information collected by the sensors 110 may be communicated to the apparatus 100. In one embodiment, the sensors 110 may be integrally arranged in the apparatus 100. In another embodiment, the sensors 110 may be arranged in an environment proximal to the apparatus 100. The sensors 110 may be in wireless communication with the apparatus 100, as described herein.

The apparatus 100 may connect with one or more user device(s) 105 associated with one or more user(s). In one embodiment, the user device 105 is a computing device comprising an interactive module. The interactive module may enable the user to communicate with the apparatus 100. Examples of the user device 105 include, but are not limited to, a desktop computer, a laptop computer, a mobile phone, a watch, a tablet, and a personal digital assistant. In one example, the interactive module is a mobile application that provides access to dual-way communication with the apparatus 100, for example, the user may communicate with the apparatus 100 via the interactive module and/or the apparatus 100 may communicate with the interactive module to provide the user with information.

The interactive module may enable the user to manage the apparatus 100 or a group of apparatuses. Management of the one or more apparatuses can include programming predetermined schedules for displaying colors associated with various meanings or information described above, and/or, can include defining messaging, images, reporting of sensor information or display of other information on an apparatus at a given time.

In some embodiments, the apparatus 100 may comprise a power source module 112 including at least one power source. In one embodiment, the power source may be integrally disposed within the apparatus 100. In one example, the power source may be a rechargeable battery system. In another example, the power source may be a removable and rechargeable battery system. In some embodiments, the power source may be provided separately from the apparatus 100. In one example, the power source may be a renewable power source. In another example, the power source may be solar based-renewable power source.

The power source module 112 may supply power to the apparatus 100. The power source module 112 may control and vary the power supplied to the apparatus 100 based on one or more conditions, which includes, but is not limited to, environmental conditions and/or status of the battery. In one example, the environmental condition includes, but is not limited to, the presence of people and the absence of people at the vicinity proximal to the apparatus 100. The apparatus 100 may operate in power saving mode in the absence of a user in the vicinity proximal to the apparatus 100. In another example, an environmental conditions such as emergency situations and/or high heat or critical cold temperatures may require the apparatus 100 to use more power to display more and/or different information relevant to the occupant viewing the device.

The plate device 102 may include a display module 106. The display module 106 may display and communicate information to the user. In some embodiments, the display module 106 may be the entire plate device 102. In some embodiments the display module 106 may be disposed on at least a portion of the plate device 102. In some embodiments, the display module 106 may be disposed at or near an edge of the plate device 102. In some embodiments, the display module 106 may be disposed above, below, or to a side of the switch 120. The display module 106 is configured to display and communicate information.

In some embodiments, the apparatus 100 may comprise one or more light emitting elements 114 to communicate information. The light emitting elements 114 may comprise one or more light emitting diodes. The light emitting elements 114 may glow or display a predetermined color to communicate to a user information, as described in more detail below, such as information about utility price rates, overall usage of utilities to encourage conservation of resources, and other information relevant to the local environment, neighborhood, or living arrangements, such as reminders about events, status of bills due, and other information.

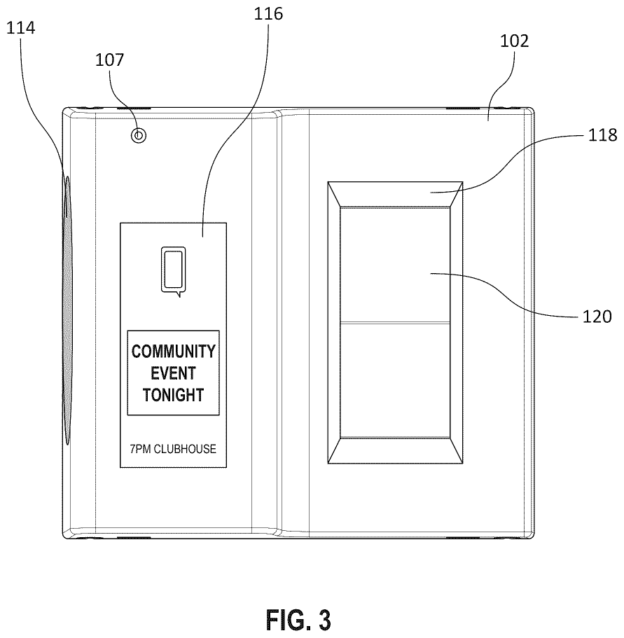

In some embodiments, the display module 106 may be a display such as, but not limited to, an electronic paper screen 116 (shown in FIG. 2 and FIG. 3.), a touch screen, and an interactive screen. The electronic paper screen 116 (e.g., electronic ink or E-ink or electrophoretic display) may display and communicate information to the user. The electronic paper screen 116 may also be referred as an electronic paper unit. Non-limiting examples of the information displayed by the electronic paper screen 116 includes air quality, environmental information, weather information, information related to time of one or more countries, utility information, information relevant to the local environment, neighborhood or living arrangements, information configured by the user, external advertisements and status of the devices connected to the apparatus 100.

In some embodiments, the apparatus 100 may include a projection mechanism 107, for example, a projector to display information to the user onto a nearby wall or ceiling of a room.

The communication module 108 may facilitate communication (e.g., wireless communication) between the apparatus 100 and the user device 105 via a network 109. Non-limiting examples of technologies that could be used in the communication module 108 includes, but are not limited to an antenna (e.g., an LTE antenna), a radio frequency transceiver, a wireless transceiver such as a Wi-Fi transceiver, a Bluetooth Low Energy (BLE) transceiver, a Bluetooth Classic transceiver, a Z-Wave transceiver, a Zigbee transceiver, an Ultra-Wideband (UWB) transceiver, or any combination thereof.

The network 109 may include one or more interconnected networks, over which the user device 105 and the apparatus 100 could communicate with each other. The network 109 generally includes, but not limited to, packet-based wide area networks (such as the Internet), local area networks (LAN), private networks, wireless networks, satellite networks, cellular networks, paging networks, and the like. A person skilled in the art will recognize that network 109 may also be a combination of more than one type of network. For example, the network 109 may be a combination of a LAN and the Internet. In addition, network 109 may be implemented as a wired network, or a wireless network or a combination thereof.

FIGS. 2, 3, 4A and 4B are perspective views of example electronic plate devices 102, according to embodiments of the present disclosure. The electronic plate device 102 comprises at least one aperture 118. The aperture 118 may receive and accommodate at least one switch 120. In some embodiments, the electronic plate device 102 can be used in connection with other household features besides light switches, for example, the aperture 118 may be configured to surround a thermostat or door handle. In one embodiment, the switch 120 is a light switch. In another embodiment, the electronic plate device 102 may be adapted and designed for plurality of switches 120. The light emitting elements 114 may be disposed on the plate device 102. The sensors 110 are configured to determine environmental conditions, and, or, detect the presence of the user at the vicinity proximal to the plate device 102.

The sensors 110 can detect that the user is near the plate device 102 using motion sensors, or that the user is viewing the area proximal to the plate device 102 by detecting the presence of some other device specific to a user such as a smartphone or other related personal device. Based on the information received by the sensor 110, the plate device 102 can display information. For example, the apparatus 100 may detect that the user is in the area proximal to the plate device 102 and displays the information related to power consumption, status of bills or rent due, community events and/or advertisements. The plate device 102 may communicate an electricity price rate for the power consumed by an environment having one or more devices. The information may be communicated using the light emitting elements 114. The light emitting elements 114 may emit a first color based on the power consumption. The first color, for example, red may represent a high power consumption rate, separate status of a high bill, or notification of overdue bills such as rent or mortgage payments. The light emitting element 114 may emit a second color based on the power consumption. The second color, for example, green may represent a normal power consumption rate.

The plate device 102 may enable the user to define one or more rules to display the information. For example, the user could define the light emitting elements 114 to display a third color, for example, blue to represent a normal power consumption rate, or another color on the last day of the month to represent a reminder of rent being due. The plate device 102 may communicate information, including but not limited to, air quality, environmental information, weather information, information related to time of one or more countries, information configured by the user, utility information, information relevant to the local environment, neighborhood or living arrangements, external advertisements and status of the devices connected to the apparatus 102. This communicated information may be displayed by showing a predefined color and/or by using the display module 106. The one or more rules can be defined by the user to instruct the plate device 102 to displayed intended information at a predetermined time.

Advantageously, the present disclosure enables the user to save energy by providing relevant information. Additionally, the present disclosure provides a new method for providing timely and relevant information in a new location to enhance reminders that improve quality of life, reduce late bill payments and provide critical messaging. Further, the apparatus 100 may display and communicate information to the user. The apparatus 100 may operate as a wireless communicating light switch plate. The information and/or positioning of the apparatus 100 is beneficial in that the apparatus 100 may be positioned around a light switch 120, which is most likely interacted with by the user at least once a day. For example, the light switch 120 may be one of the last things a user interacts with or looks at before leaving their house for the day and it can provide them with information beneficial for proceeding with their day.

FIG. 3 is an alternate perspective view of the electronic plate device 102, according to an embodiment of the present disclosure. The embodiments of FIG. 3 may include some or all of the features described in connection with FIGS. 2, 4A, 4B, 5E, and 5F. In this example embodiments, the electronic paper screen 116 may be positioned to the left or right of the light switch 120. The light emitting elements 114 may be positioned to the left or right of the device 102. In another embodiment, a projection mechanism 107 may be used to display images onto the nearby wall or ceiling.

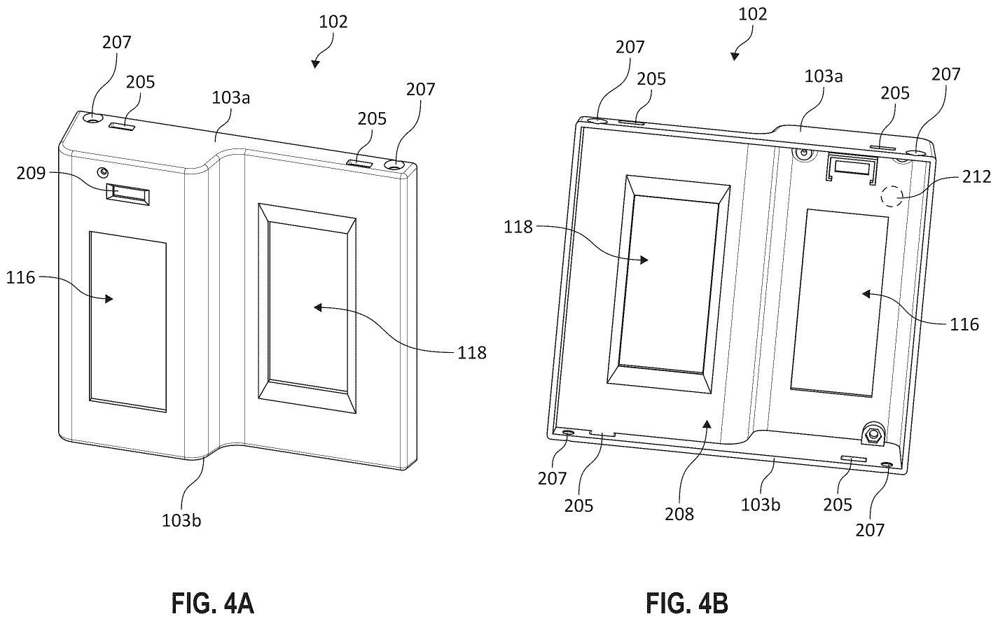

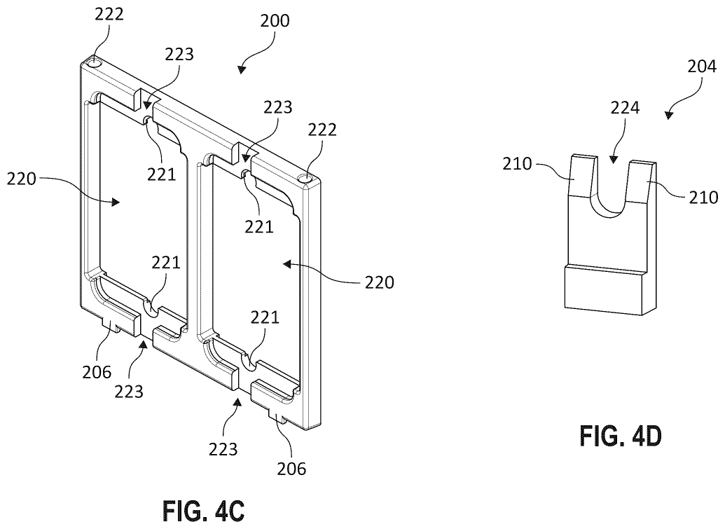

FIGS. 4A and 4B illustrate an alternative embodiment of the electronic plate device 102, according to an embodiment of the present disclosure. The embodiments of FIG. 4A and 4B may include some or all of the features described in connection with FIGS. 2, 3, 5E, and 5F. FIG. 4C is a perspective view of an example embodiment of a mounting plate 200, according to an embodiment of the present disclosure. The mounting plate 200 can be used to mount an electronic plate device, for example, the electronic plate device 102 described with reference to FIGS. 3, 4A and 4B. FIG. 4D is an example embodiment of a mounting key 204 that can be used to mount the mounting plate 200 around a switch, for example switch 120.

The electronic plate device 102 can be designed to fit around any light switch apparatus (e.g., an existing light switch apparatus), regardless of the location of the screws used to affix the light switch to a wall, or electrical box adhered to a wall. While the current presentation includes a ‘single-gang’ or single switch, the invention can be modified to fit around a multiple gang light switch (e.g., around an existing multiple gang light switch) using the same innovation, processes, and mounting methods described here. The electronic plate device 102 can have a recessed area 208, as shown in FIG. 4B, that can be positioned over or around the light switch. The light switch can be accessible through the aperture 118. While FIG. 4A illustrates the electronic plate device 102 having the aperture 118 on the right side and the display screen 116 on the left, the electronic plate device 102 can be rotated about 180 degrees and also used with the aperture 118 on the left side and the display screen 116 on the right side. The electronic plate device 102 can include an internal gyroscope 212. The internal gyroscope 212 can sense or identify which orientation the electronic plate device 102 is in. For example, is the display screen 116 on the left or right and/or which way is up or down. The internal gyroscope 212 can be used to ensure the display screen 116 displays in the correct orientation.

The electronic plate device 102 can include one or more openings or recesses 205. In some embodiments, the one or more openings or recesses 205 can be positioned on top and/or bottom surfaces of the electronic plate device 102. In some embodiments, the one or more openings or recesses 205 can be positioned on edges of the electronic plate device 102. The one or more openings or recesses 205 can be positioned to align with corresponding protrusions 206 of the mounting plate 200, as described herein. The electronic plate device 102 can include one or more openings 207 to receive screws when mounting the electronic plate device 102 to the mounting plate 200. In some embodiments, the openings 207 can be positioned on top and/or bottom surfaces of the electronic plate device 102. In some embodiments, the openings 207 can be positioned on edges of the electronic plate device 102. In some embodiments, the openings or recesses 205 and/or the openings 207 can be uniformly positioned on a top surface 103a and a bottom surface 103b of the electronic plate device 102 (e.g., the openings or recesses 205 and/or the openings 207 on the top surface 103a align with the openings or recesses 205 and/or the openings 207 on the bottom surface 103b). The uniform positioning can be advantageous as it can allow the electronic plate device 102 to be mounted with the display device 116 on the left or right. The electronic plate device 102 can include an interactive button 209. The interactive button 209 can allow a user to turn the display 116 on or off and/or can allow a user to select the type of information displayed (e.g., actuation, such as pressing, of the interactive button 209 can toggle between different type of information displayed or acknowledge receipt of messaging on the display 116).

With reference to FIG. 4C, the mounting plate 200 can include one or more receiving areas 220. The receiving areas 220 can be sized and shaped to be positioned around one or more light switches (e.g., existing light switches), according to the present disclosure. The receiving areas 220 can be sized such that they can be positioned around any standard size light switch. The receiving areas 220 can include one or more recesses or notches 221 extending into the perimeter of the recessed areas 220. The recesses or notches 221 can be sized to be positioned at least partially around a screw that secures the light switch to a wall or other surface. In some embodiments, the recesses or notches 221 may be curved. The recesses or notches 221 can be positioned to align with the standard positions of the screws that secure the light switch. For example, the recesses or notches 221 can be positioned in top and bottom positions of the perimeter of the recessed areas 220.

The mounting plate 200 may include the one or more protrusions 206 described above. The protrusions 206 can be positioned to align with the openings or recesses 205 of the electronic plate device 102. In some embodiments, the protrusions 206 may be positioned on a bottom facing surface of the mounting plate 200. In some embodiments, the protrusions 206 may be positioned on a top facing surface of the mounting plate 200. In some embodiments, the protrusions 206 may be positioned on both the bottom facing and top facing surfaces of the mounting plate 200.

In some embodiments, the mounting plate 200 may include one or more openings 222 to receive screws when mounting the electronic plate device 102 to the mounting plate 200. The one or more openings 222 can be positioned to align with the openings 207 of the electronic plate device 102.

In some embodiments, the mounting plate 200 can include one or more key slots 223. The key slots 223 can be sized to receive a mounting key 204. The key slots 223 can be aligned with the recesses or notches 221.

FIG. 4D illustrates an example embodiment of the mounting key 204. The mounting key 204 can include a cutout 224. The cutout 224 can be sized to rest around a screw shaft. The mounting key 204 can be sized to fit within the key slot 223 of the mounting plate 200. The mounting key 204 can be inserted into the key slot 204 such that the cutout 224 is positioned around the screw shaft of the screws that secure the light switch to the wall or other surface, according to the present disclosure. The mounting key 204 can include a tapered end 210. The tapered end 210 can be positioned adjacent the cutout 224. In some embodiments, the tapered end 210 can be sidewalls defining a portion of the cutout 224. In some embodiments, the tapered end 210 can include two portions. The tapered end 210 can decrease in thickness as it extends from an inward location of the mounting key 204 to an end location. The tapered end 210 can allow the mounting key 204 to more easily slide over or around the screw shaft between the mounting plate 200 and the screw head.

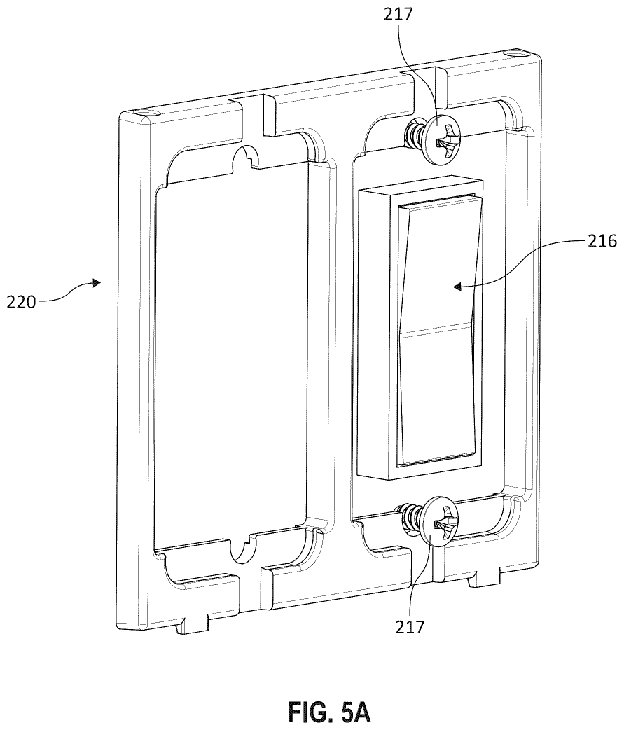

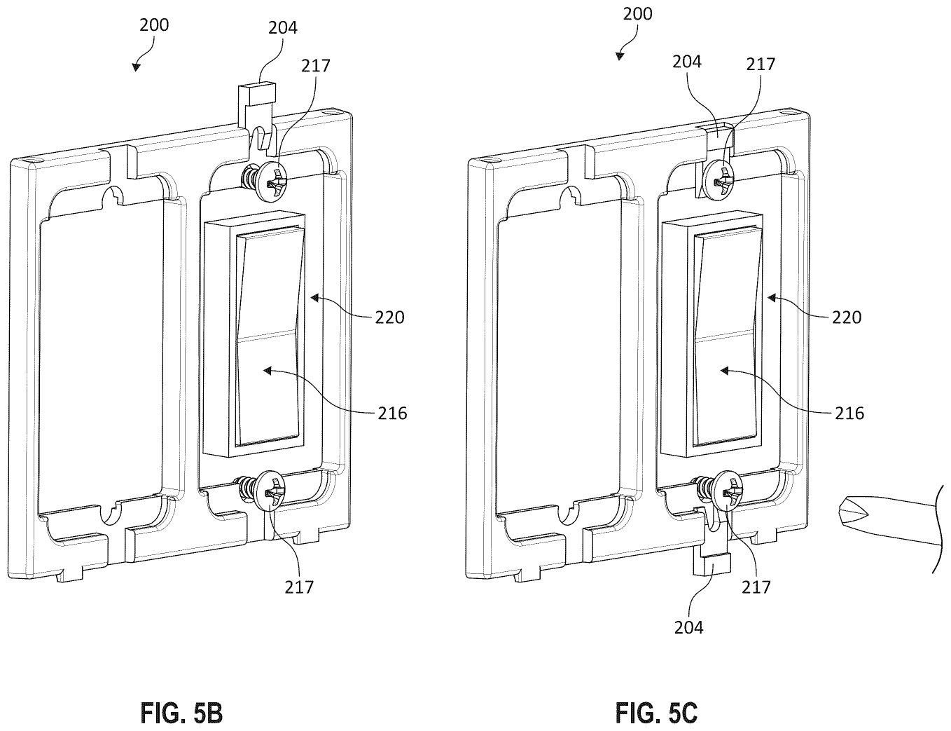

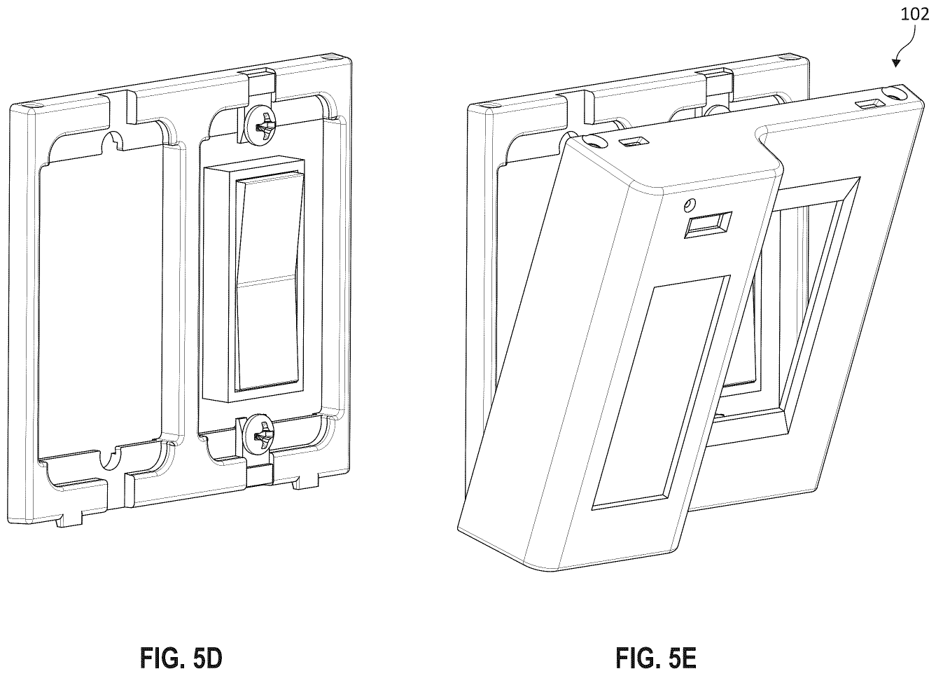

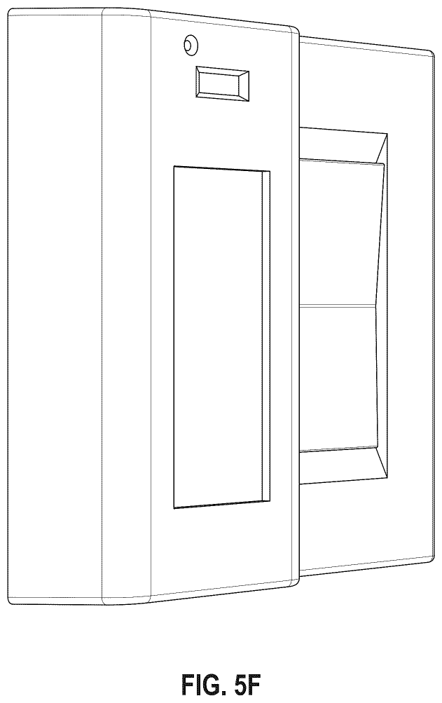

FIGS. 5A-5F illustrate an example method of mounting the electronic plate device 102 using the mounting plate 200 and mounting keys 204. The electronic plate device 102 can replace the cover or plate of a light switch 216 (e.g., an existing light switch 216). The electronic plate device 102 can be secured to the wall using the same screws 217 that secure the cover or plate of the light switch 216 to the wall.

Starting at FIG. 5A, the original backplate or cover has been removed. The screws that affix the switch and/or original black plate or cover to the wall can be loosened. The mounting plate 200 can be placed around the screws, as shown in FIG. 5A. For example, the mounting plate 200 can be positioned such that the screws are positioned in the recesses or notches 221. The mounting plate 200 can be positioned such that the light switch 216 is positioned in one of the receiving areas 220.

Moving to FIGS. 5B and 5C, one or more mounting keys 204 can be inserted into the key slots 223. Before tightening the screws, the mounting key(s) 204 can be inserted around the screw(s) 217 (e.g., so that the mounting key 204 is adjacent or in contact with the screw 217). The screw(s) 217 can then be tightened. The mounting key 204 can be used to close the space around the screw 217 and the screw 217 is screwed against the mounting key 204, which can be pressed against the mounting plate 200. FIG. 5D illustrates the mounting plate 200 secured to the wall using the mounting keys 204.

Moving to FIG. 5E, the electronic plate device 102 can be positioned over the mounting plate 200. The openings or recesses 205 of the electronic plate device 102 can be aligned with the protrusions 206 of the mounting plate 200. When positioning the electronic plate device 102, it can be angled such that the protrusions 206 can engage the openings or recesses 205.

Screws can then be inserted through the openings 207 of the electronic plate device 102 and into the openings 222 of the mounting plate 200. The screws can be used to affix the electronic plate device 102 to the mounting plate 200. FIG. 5F illustrates the electronic plate device 102 mounted to the mounting plate 200 and thereby to a wall.

A user can then connect to the system via a QR code unique to each electronic plate device 102 via a display on the device. The QR code can be scanned with a phone or other electronic device. The installer could then log information such as the location of the device (e.g., property/address/apartment number etc.). The electronic plate device 102 could then be operational.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. An interactive plate apparatus, comprising:
an electronic light switch accessory device mounted to a surface at least partially surrounding a light switch, the electronic light switch accessory device comprising:
at least one opening sized to receive the light switch;
one or more light emitting elements disposed on the electronic light switch accessory device;
a computing module configured to be in communication with the one or more light emitting elements and the electronic light switch accessory device; and
one or more sensors configured to collect information related to an environment surrounding the electronic light switch accessory device, wherein the one or more sensors are in communication with the electronic light switch accessory device, and wherein the electronic light switch accessory device is configured to communicate information to a user.

2. The apparatus of claim 1, wherein the electronic light switch accessory device comprises a display module.

3. The apparatus of claim 1, wherein the electronic light switch accessory device is configured to communicate localized information relevant to one or more specific users of the electronic light switch accessory device.

4. The apparatus of claim 3, wherein the electronic light switch accessory device is configured to communicate via at least one of an electronic paper screen and the one or more light emitting elements.

5. The apparatus of claim 1, wherein the electronic light switch accessory device is configured to display information related to the environment or a particular time.

6. The apparatus of claim 2, wherein the display module is a screen.

7. The apparatus of claim 1, wherein at least one of the one or more sensors are configured to detect a user's presence.

8. The apparatus of claim 1, wherein the interactive plate apparatus transitions to a power saving mode when a user's presence is not detected.

9. A light switch accessory at least partially surrounding a light switch comprising:
at least one opening sized to receive the light switch;
one or more sensors configured to receive information from an environment surrounding the light switch accessory; and
a display module configured to display the information received by the one or more sensors.

10. The light switch accessory of claim 9, further comprising one or more light emitting elements configured to display one or more predetermined colors representing a predetermined set of information.

11. The light switch accessory of claim 9, wherein the light switch accessory is configured to communicate information to a user device.

12. The light switch accessory of claim 9, wherein display module is an electronic paper screen.

13. The light switch accessory of claim 10, wherein the one or more light emitting elements display a first color to communicate a first set of information and wherein the one or more light emitting elements display a second color to communicate a second set of information, wherein the second color is different than the first color.

14. The light switch accessory of claim 9, wherein at least one of the one or more sensors are configured to measure environmental conditions and air quality.

15. A method of displaying information on a light switch accessory comprising:
detecting information from an environment where the light switch accessory is positioned using one or more sensors positioned on the light switch accessory;
detecting a user's presence using the one or more sensors; and
displaying at least a portion of the information detected on at least one of a display module or one or more light emitting elements.

16. The method of claim 15, further comprising communicating the detected information to a user device.

17. The method of claim 15, further comprising transitioning the light switch accessory to a power save mode when the user's presence is no longer detected.

18. The method of claim 15, further comprising the one or more light emitting elements displaying a first color to communicate a first set of information and displaying a second color to communicate a second set of information, wherein the second color is different than the first color.

19. The method of claim 15, further comprising displaying the detected information using a projector.

20. A method of mounting a light switch accessory comprising:
positioning a mounting plate around a light switch;
aligning the mounting plate with a screw;
inserting a mounting key into a key slot of the mounting plate, such that a cutout of the mounting key is positioned at least partially around a shaft of the screw;
tightening the screw to secure the mounting key and mounting plate to a surface; and
positioning the light switch accessory over the mounting plate.
